(19) United States
(12) Patent Application Publication
(10) Pub. No.: US 2025/0285635 A1
(43) Pub. Date: Sep. 11, 2025

(54) SWITCHING AI-BASED AUDIO PROCESSING BETWEEN TX AND RX CHANNELS

(71) Applicant: SKYWORKS SOLUTIIONS, iNC., Irvine, CA (US)

(72) Inventor: Alexander Kain, Portland, OR (US)

(21) Appl. No.: 19/070,616

(22) Filed: Mar. 5, 2025

Related U.S. Application Data
(60) Provisional application No. 63/561,498, filed on Mar. 5, 2024.

(51) Int. Cl. G10L 21/0216; H04R 5/033; H04R 5/04

(52) U.S. Cl. CPC G10L 21/0216; H04R 5/033; H04R 5/04; G10L 2021/02163

(57) ABSTRACT

Herein is presented a system for processing a targeted signal. The system includes a first audio signal input configured to provide a first audio signal; a second audio signal input configured to provide a second audio signal; at least one switching device coupled to the first audio signal input and the second audio signal input, and configured to provide the targeted signal to the processing circuit, the targeted signal being based on the first audio signal or the second audio signal; a processing circuit coupled to the at least one switching device and configured to process the targeted signal; and at least one controller configured to determine a state of the at least one switching device based on one or more of the first audio signal and the second audio signal.

### CROSS-REFERENCE TO RELATED APPLICATIONS

This application claims priority under 35 U.S.C. § 119(e) to U.S. Provisional Application No. 63/561,498, titled SWITCHING AI-BASED AUDIO PROCESSING BETWEEN TX AND RX CHANNELS, filed on Mar. 5, 2024, which is hereby incorporated by reference in its entirety for all purposes.

### BACKGROUND

### 1. Field of the Disclosure

At least one example in accordance with the present disclosure relates generally to audio processing for edge device.

### 2. Discussion of Related Art

Electrical signals may be processed to change the signal, for example, by removing and/or attenuating unwanted frequency components, or providing gain to desirable frequency components of the signal.

### SUMMARY

According to at least one aspect of the present disclosure a system for processing a targeted signal is presented, the system comprising: a first audio signal input configured to provide a first audio signal; a second audio signal input configured to provide a second audio signal; at least one switching device coupled to the first audio signal input and the second audio signal input, and configured to provide the targeted signal to the processing circuit, the targeted signal being based on the first audio signal or the second audio signal; a processing circuit coupled to the at least one switching device and configured to process the targeted signal; and at least one controller configured to determine a state of the at least one switching device based on one or more of the first audio signal and the second audio signal.

In some examples, processing the targeted signal includes using artificial intelligence-based noise suppression. In some examples, the system further comprises at least one sensor configured to provide data to the at least one controller. In some examples, the data includes one or more of voice data, energy data, background noise data, and motion data. In some examples the first audio signal input is a microphone configured to sense a sound and convert the sound into the first audio signal. In some examples, the second audio signal input is a receiver configured to receive the second audio signal. In some examples the at least one switching device includes a first switching device coupled between the processing circuit and the first audio signal input and a second switching device coupled between the processing circuit and the second audio signal input, the at least one controller being configured to control respective states of both the first switching device and the second switching device.

According to at least one aspect of the present disclosure, a system for processing audio signals is presented, comprising: a transceiver; an input-output interface; one or more switching devices coupled to the transceiver and coupled to the input-output interface; a processing circuit coupled to the one or more switching devices; and at least one controller coupled to the processing circuit and coupled to the one or more switching devices and configured to: detect an RX signal received at the transceiver, detect a TX signal received at the input-output interface, and based on the RX signal and the TX signal, control the one or more switching devices to route one of the TX signal or the RX signal to the processing circuit and route the other of the TX signal or RX signal to the transceiver or input-output interface.

In some examples, the transceiver includes a receiver configured to receive RX audio signals, and a transmitter configured to transmit TX audio signals. In some examples, the input-output interface includes a microphone configured to convert sound into TX audio signals, and one or more speakers configured to convert RX audio signals into sound. In some examples, the transmitter is coupled to a first switching device of the one or more switching devices, and the receiver is coupled to the first switching device. In some examples, the microphone is coupled to a second switching device of the one or more switching devices, and the one or more speakers are coupled to the second switching device. In some examples, the first switching device is coupled to the second switching device. In some examples, the first switching device is configured to selectively couple the transmitter and receiver to the processing circuit and second switching device. In some examples, the second switching device is configured to selectively couple the microphone and the one or more speakers to the processing circuit and first switching device. In some examples, the at least one controller is further configured to control a state of the one or more switching devices, including the first switching device and the second switching device, based on one or more of the RX audio signals or the TX audio signals. In some examples, the system further comprises at least one sensor configured to provide data to the at least one controller.

According to at least one aspect of the present disclosure, a method of processing an audio signal is presented, comprising: receiving one or more audio signals; responsive to receiving the one or more audio signals, determining an audio signal of the one or more audio signals to be a targeted audio signal, the targeted audio signal being an audio signal of the one or more audio signals that corresponds to a most important audio signal among the one or more audio signals.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates an audio system according to an example;

FIG. 2 illustrates an audio system according to an example;

FIG. 3 illustrates an audio system according to an example;

FIG. 4 illustrates an audio system according to an example; and

FIG. 5 illustrates a process for audio processing according to an example.

### DETAILED DESCRIPTION

In many telecommunication applications, such as telephonic communications, internet communications, and so forth, audio signals transmitted from a source to a destination may include background noise. For example, in many VoIP conversations in populated areas, the sounds of other people, vehicles, machines, or other things in the area, may be transmitted along with the audio that the user intends to transmit (e.g., the user's voice).

Various audio and/or signal processing techniques may be used to adjust or eliminate background noise in signals. For example, artificial intelligence based processing techniques may be used to adjust the audio signal transmitted from the source to the destination. For example, artificial intelligence techniques may be used to provide noise suppression to the audio signal. Artificial intelligence noise suppression (AINS) techniques may therefore be used to attenuate and/or remove the unwanted noises (such as the sounds of other people, vehicles, machines, and so forth) so that the wanted elements of the audio signal are more prominent in the signal or are the only parts of the signal that are transmitted to the destination.

Edge devices, which are typically battery-powered, wearable devices with limited power, size, and performance, may lack the capability to use AINS techniques on multiple signals simultaneously.

Aspects and elements of this disclosure relate to using AI-based techniques, including AINS, on edge devices in an efficient and effective manner. In examples herein, a half-duplex approach may be used, so that the AINS techniques (or other AI-based techniques) may be applied only to one signal at a time. In examples herein, additional techniques may be used which allow the edge device to identify an important signal, the important signal being the signal which should have an AI-based technique (such as AINS) applied to it.

For example, suppose an end-user (“user”) has a headset device with limited processing power. The headset device may have an audio output, such as a speaker, and an audio input, such as a microphone. As a result, at any given time, the user may be receiving one or more signals (a received signal may be referred to as an “RX signal” or “RX stream”) and transmitting one or more signals (a transmitted signal may be referred to as a “TX signal” or a “TX stream”). The headset may identify, from among the myriad TX and RX signals, a specific signal to be adjusted, for example, by removing from the specific signal unwanted background noise using AINS techniques.

The signal that received processing may be referred to as the “targeted signal,” as said signal is being targeted by the device for processing (e.g., via AINS or other techniques). The targeted signal may be determined and/or changed dynamically by the device. In some examples, sensors may be used to detect which signal should be the targeted signal. In some examples, computational techniques (such as statistical techniques, AI-based techniques, analysis techniques, and so forth) may be used to determine the targeted signal. In some examples, combinations of approaches (e.g., sensors and non-sensor techniques) may be used.

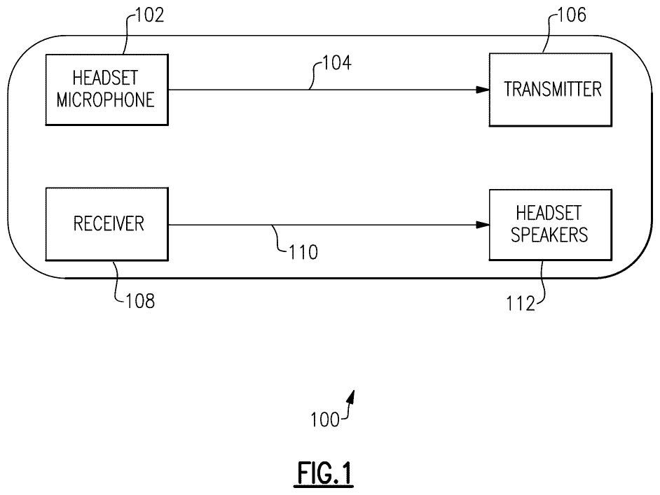

FIG. 1 illustrates a system 100 for applying processing to a targeted signal according to an example. The system 100 includes a headset microphone 102, a first link 104, a transmitter 106, a receiver 108, a second link 110, and headset speakers 112.

The system 100 is configured to receive and transmit signals. For example, the headset microphone 102 and headset speakers 112 may be parts of the same headset. When a signal is transmitted, the TX signal may originate with the headset microphone 102 and be provided via the first link 104 to the transmitter 106. The transmitter 106 may then transmit the TX signal to a different device (e.g., a host). When the headset is receiving a signal, the RX signal may be received (e.g., from the host) at the receiver 108 and transmitted via the second link 110 to the headset speakers 112. In some examples, the transmitter 106 and receiver 108 may be part of the same headset as the headset microphone 102 and the headset speakers 112. In some examples, the transmitter 106 and receiver 108 may be one device (e.g., a transceiver). In some examples, there may be one or more TX signals and/or one or more RX signals.

The system 100 may send and receive signals sequentially and/or simultaneously. The system 100 may apply processing to the TX and RX signals to adjust those signals. In some examples, the processing may include AI-based techniques, such as AINS. The headset may not be able to apply AI-based techniques (or processing, more generally) to both TX and RX signals simultaneously. The system 100 may be configured to identify a targeted signal and from among the various TX and RX signals and apply processing (e.g., AINS or other AI-based techniques) to only the targeted signal.

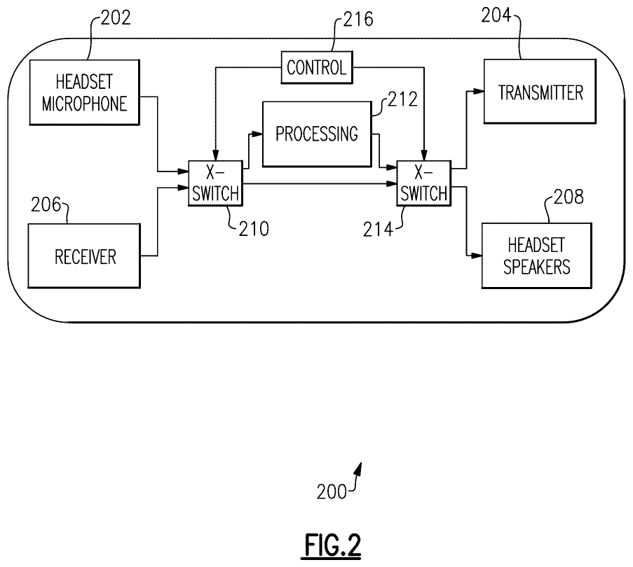

FIG. 2 illustrates a system 200 for applying processing to a targeted signal according to an example. The system 200 includes a headset microphone 202, a transmitter 204, a receiver 206, headset speakers 208, a first switch 210, a processing circuit 212, a second switch 214, and at least one controller 216 (“controller 216”).

The system 200 is configured to apply processing to a targeted signal. The headset microphone 202 is coupled to the first switch 210. The receiver 206 is coupled to the first switch 210. The first switch 210 is coupled to the processing circuit 212 and the second switch 214. The processing circuit 212 is coupled to the first switch 210 and the second switch 214. The second switch 214 is coupled to the transmitter 204 and to the headset speakers 208. The controller 216 may be communicatively coupled the first switch 210 and to the second switch 214, and may additionally be communicatively coupled to the processing circuit 212, the transmitter 204, the receiver 206, the headset microphone 202, and/or the headset speakers 208.

There are at least two potential processing paths in the system 200. A first path corresponds to processing a TX signal originating from the headset microphone 202 and being transmitted to another device via the transmitter 204. A second path corresponds to processing an RX signal received at the receiver 206, provided to and output by the headset speakers 208. TX and RX signals may be present in the system 200 simultaneously or sequentially. In some examples, sequences of RX and TX signals may rapidly alternate between TX and RX signals (e.g., an RX signal may be received at a first time, a TX signal at a second time shortly later, and another RX signal at a third time shortly after the first time or the second time). The switches 210, 214 route a targeted signal to the processing circuit 212, and may allow other signals to bypass the processing circuit 212, thereby reserving the resources of the processing circuit 212 for the targeted signal while still allowing receipt or transmission of other signals.

The headset microphone 202 is configured to receive sounds and convert those sounds into electrical signals (for example, the TX signal), and then to provide the TX signal to the first switch 210. The headset microphone 202 may contain, for example, a diaphragm, magnet, coil, and so forth, that are configured to convert sounds into electrical signals.

The receiver 206 is configured to receive a signal (for example, the RX signal) from another device and to provide the RX signal to the first switch 210. The RX signal received by the receiver 206 may be, for example, a signal corresponding to a desired sound to be output by the headset speakers 208.

The transmitter 204 is configured to receive a signal (e.g., the TX signal) and transmit the TX signal to another device, such as a computer, phone, radio, and so forth.

The headset speakers 208 are configured to receive an electrical signal (e.g., the RX signal) and convert the RX signal into sound. The headset speakers 208 may contain, for example, a diaphragm, magnet, coil, and so forth, that are configured to convert electrical signals into sound. The headset speakers 208 may be configured to sit in or near the ear of a user so that the user may hear the sound generated based on the signal (e.g., based on the RX signal). The headset speakers 208 may contain amplifiers or other circuitry configured to adjust the gain and/or attenuation of the RX signal (e.g., to make the RX signal louder or quieter).

The first switch 210 is configured to select between the headset microphone 202 and the receiver 206 and route the signals received from one of those two components to the processing circuit 212 at a time. For example, the headset microphone 202 provides TX signals and the receiver 206 provides RX signals to the first switch 210. Thus, the first switch 210 may route one of the TX signals or the RX signals to the processing circuit 212 (the signal provided to the processing circuit 212 therefore being the targeted signal). The first switch 210 may be further configured to directly route whichever of the TX or RX signals is not the targeted signal to the second switch 214, thereby bypassing the processing circuit 212. The signal that bypasses the processing circuit 212 may be referred to hereafter as the bypassed signal.

The first switch 210 may have a first state corresponding to providing the TX signal to the processing circuit 212 (e.g., as the targeted signal) and/or providing the RX signal to the second switch 214 (e.g., as the bypassed signal). The first switch 210 may have a second state corresponding to providing the RX signal to the processing circuit 212 (e.g., as the targeted signal) and/or providing the TX signal to the second switch 214 (e.g., as the bypassed signal).

The second switch 214 is configured to receive the targeted signal and/or the bypassed signal and route those signals to the transmitter 204 and the headset speakers 208. In particular, the second switch 214 may be configured to route whichever of the bypassed signal and the targeted signal corresponds to the TX signal to the transmitter 204, and whichever of the bypassed signal and the targeted signal corresponds to the RX signal to the headset speakers 208.

The second switch 214 may have a first state corresponding to providing the targeted signal to the transmitter 204 and/or the bypassed signal to the headset speakers 208. The second switch may have a second state corresponding to providing the bypassed signal to the transmitter 204 and/or the targeted signal to the headset speakers 208.

The processing circuit 212 applies processing to the targeted signal. The processing applied may include AI-based techniques, such as AINS. The processing may remove or attenuate unwanted background noise from the targeted signal whether the targeted signal is derived from a TX signal or an RX signal. The processing may adjust the targeted signal in various other ways as well or in addition to those described above, for example by adjusting the harmonic components of the targeted signal, adjusting attenuation and/or gain for specific frequencies making up the targeted signal, adjust the speed or tone of the signal, and so forth.

The controller 216 may control the states of the switches 210, 214. In some examples, the controller 216 may control the processing circuit 212, for example, by determining what sort of processing the processing circuit 212 should provide to the targeted signal. The controller 216 may determine the state of the switches 210, 214 based on a determination of which signal should be the targeted signal. For example, if the TX signal is the targeted signal, the controller 216 may control the first switch 210 to be in the first state and the second switch 214 to be in the first state. For example, if the RX signal is the targeted signal, the controller 216 may control the first switch 210 to be in the second state and the second switch 214 to be in the second state.

The controller 216 may determine which signal should be the targeted signal in various ways. In some examples, the controller 216 may use a sensor input to determine the targeted signal. For example, if the headset microphone 202 includes a sensor configured to detect motion of the user's jaw (e.g., via conduction, movement detection, and so forth), the controller 216 may determine that the user is talking and therefore that the TX signal should be the targeted signal. In some examples, if the user is not talking (e.g., motion of the jaw is not detected), the controller 216 may determine that the TX signal should not be the targeted signal (and may default to considering the RX signal to be the targeted signal). In some examples, the controller 216 may determine which signal should be the targeted signal based on the duration of the signal (e.g., the controller 216 may favor signals with longer or shorter durations, or may favor continuous signals over discontinuous signals). In some examples, the controller 216 may determine which signal should be the targeted signal based on another metric, such as the relative power of the signals (e.g., power spectral density), whether a signal contains frequency components corresponding to the human voice, whether the user has designated a particular signal for processing, and so forth. In some examples, the controller 216 may use an AI-algorithm to identify which signal should be the targeted signal.

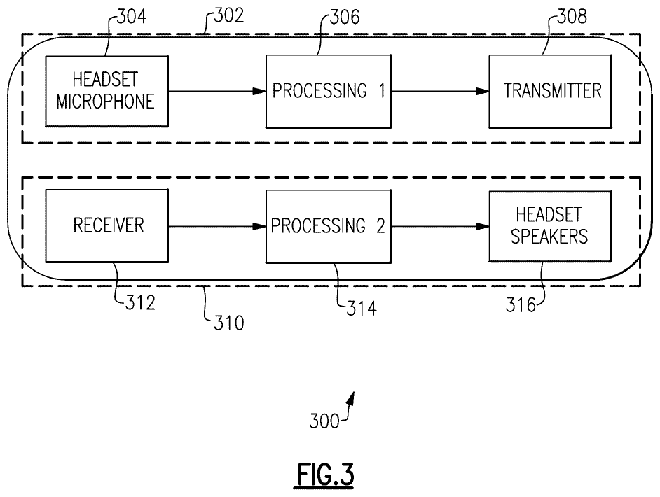

FIG. 3 illustrates a system 300 for providing processing to a targeted signal according to an example. The system 300 is similar to the system 200 and shows the processing paths in an explicitly separated configuration.

The system 300 includes a first processing path 302 (“first path 302”), a headset microphone 304, a first processing circuit 306, a transmitter 308, a second processing path 310 (“second path 310”), a receiver 312, a second processing circuit 314, and headset speakers 316.

The headset microphone 304 and headset speakers 316 may be part of the same headset. The transmitter 308 and receiver 312 may be part of the same headset and/or may be part of the same circuit (e.g., the same transceiver). The first processing circuit 306 and second processing circuit 314 may be part of the same headset and/or may be part of the same circuit (e.g., the same processing circuit).

The first path 302 corresponds to processing of a TX signal. The second path 310 corresponds to processing of an RX signal.

The headset microphone 304 is configured to convert sound into a TX signal and to provide the TX signal to the first processing circuit 306. The first processing circuit 306 is configured to process the TX signal (e.g., by applying AI-based techniques, such as AINS), or not (e.g., to simply bypass the TX signal). The first processing circuit 306 is further configured to provide either the processed TX signal (e.g., the targeted signal) or the bypassed TX signal (e.g., the bypassed signal) to the transmitter 308. The transmitter 308 is configured to transmit the TX signal (either as a bypassed signal if the TX signal was not processed or as the targeted signal if the TX signal was processed) and provide the TX signal to another device (e.g., via wireless or wired transmission).

The receiver 312 is configured to receive an RX signal from another device (e.g., via wireless or wired transmission), and to provide the RX signal to the second processing circuit 314. The second processing circuit 314 is configured to either process the RX signal (e.g., by applying AI-based techniques, such as AINS) or not (e.g., to simply bypass the RX signal). The second processing circuit 314 is further configured to provide either the processed RX signal (e.g., the targeted signal) or the bypassed RX signal (e.g., the bypassed signal) to the headset speakers 316. The headset speakers 316 are configured to receive the RX signal (either as the bypassed signal if the RX signal was not processed or as the targeted signal if the RX signal was processed), and convert the RX signal from electrical form into sound (e.g., sound audible to the user of the headset).

In some examples, the system 200 may require less computation time compared to the system 300, and the battery life of the system 200 may be greater than that of system 300 (e.g., the system 200 may use less power than that of system 300).

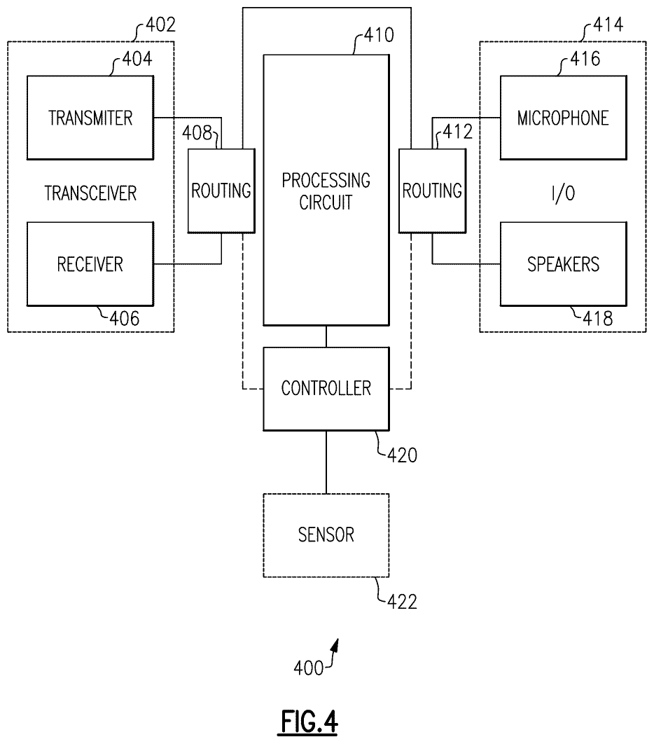

FIG. 4 illustrates an audio system 400 according to an example. The audio system 400 is, in some example, an edge device, such as a headset. The audio system 400 includes a transceiver 402, a processing circuit 410, a first routing device 408, a second routing device 412, an input and output interface 414 (“IO interface 414”), and at least one controller 420 (“controller 420”). The transceiver 402 includes a transmitter 404 and a receiver 406. The IO interface 414 includes a microphone 416 and one or more speakers 418 (“speakers 418”). The audio system 400 may also include one or more optional sensors 422 (“sensor 422”).

The transceiver 402 is coupled to the first routing device 408. In some examples, the transmitter 404 is coupled to a first connection of the first routing device 408 and the receiver 406 is coupled to a second connection of the first routing device 408. The first routing device 408 is further coupled (via a third connection) to the processing circuit 410 and via a fourth connection to the second routing device 412. The processing circuit 410 is coupled to the first routing device 408 and to the second routing device 412. The second routing device 412 is further coupled to the IO interface 414. In some examples, the second routing device 412 is coupled to the microphone 416 via a first connection and to the speakers 418 via a second connection. The controller 420 is communicatively coupled to the first routing device 408, the second routing device 412, and to the processing circuit 410. The controller 420 may also be coupled to the transceiver 402 and/or IO interface 414, and may be individually coupled to any constituent elements of the transceiver 402 and/or IO interface 414. The sensor 422 may be coupled to the controller 420.

The transceiver 402 is configured to send and receive signals (e.g., wirelessly or via a wired connection) to and/or from the audio system 400 and at least one other device (such as a computer). The transmitter 404 may, for example, transmit a TX signal originating with the audio system 400 to one or more other devices. The receiver 406 may, for example, receive an RX signal originating with one or more other devices, and provide the RX signal to the audio system 400.

The IO interface 414 is configured to provide RX signals as sound to the user and to convert sound into TX signals from the user. The microphone 416 may convert sound (e.g., from the user or the space around the user) into electrical signals for use by the audio system 400. The speakers 418 may convert electrical signals within the audio system 400 into audible sound.

The first routing device 408 is configured to route RX signals from the receiver 406 to the processing circuit 410 or to the second routing device 412, depending on whether the RX signal is the targeted signal. The first routing device 408 is further configured to route TX signals from the processing circuit 410 or from the second routing device 412 to the transmitter 404 depending on whether the TX signal is the targeted signal. The first routing device 408 may include one or more switches to control the routing.

The second routing device 412 is configured to route RX signals from the processing circuit 410 or the first routing device 408 to the speakers 418, depending on whether the RX signal is the targeted signal. The second routing device 412 is further configured to route TX signals from the microphone 416 to the processing circuit 410 or the first routing device 408, depending on whether the TX signal is the targeted signal. The second routing device 412 may include one or more switches to control the routing.

When a signal is not a targeted signal (e.g., the signal is a bypassed signal), the routing devices 408, 412 may provide the signal directly to one another. For example, when a TX signal is the bypassed signal, the second routing device 412 may provide the TX signal directly to the first routing device 408. When an RX signal is the bypassed signal, the first routing device 408 may provide the RX signal directly to the second routing device 412.

The processing circuit 410 is configured to process the targeted signal (e.g., a TX or RX signal) and provide the targeted signal to one of the routing devices 408, 412. When a TX signal is the targeted signal, the processing circuit 410 may provide the targeted signal to the first routing device 408. When an RX signal is the targeted signal, the processing circuit 410 may provide the targeted signal to the second routing device 412.

The sensor 422 is configured to provide data to the controller 420. For example, the sensor may be a motion sensor, a bone conduction sensor, a sound sensor, an energy sensor, and so forth. The sensor 422 may therefore provide information indicative of the motion of the user, the speaking of the user, the sounds made by the user and/or around the user, and/or the energy of sounds made by the user and/or around the user. In some examples, the sensor 422 and/or audio system 400 may include voice activity detections systems, such as those disclosed in U.S. U.S. Pat. No. 11,614,916, titled “User Voice Activity Detection,” which is hereby incorporated by reference in its entirety.

The controller 420 is configured to control the system 400 and to determine which signal (among all available signals, e.g., all TX and RX signals) should be the targeted signal. The controller 420 may control the state of the first routing device 408 and/or second routing device 412. For example, the controller 420 may determine whether the first routing device 408 has connected the transmitter 404 or the receiver 406 to the processing circuit 410 and/or whether the first routing device 408 has connected the receiver 406 and/or transmitter 404 to the second routing device 412 (e.g., bypassing the processing circuit 410). Similarly, the controller 420 may determine whether the second routing device 412 has connected the microphone 416 and/or the speakers 418 to the processing circuit 410 and/or whether the second routing device 412 has connected the speakers 418 and/or the microphone 416 to the first routing device 408 (e.g., bypassing the processing circuit 410).

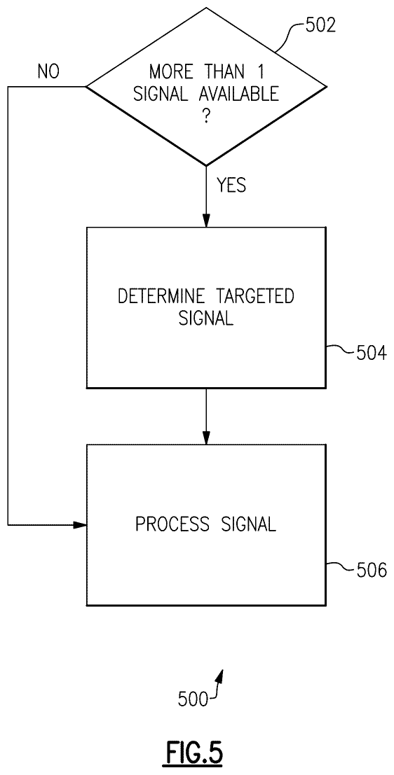

FIG. 5 illustrates a process 500 for processing a targeted signal according to an example.

At act 502, a controller (such as the controller 420) determines how many signals are being received. If the controller determines that only one signal is being received (502 NO), whether the signal is a TX signal or an RX signal, the process 500 may continue to act 506. If the controller determines that more than one signal is being received (e.g., two or more signals, whether those signals are RX signals, TX signals, or a mix of RX and TX signals) (502 YES), the process 500 may then continue to act 504.

At act 504, the controller determines which signal among the multiple signals should be the targeted signal, and thus should be processed using the limited resources of the edge device (e.g., the headset). The controller may determine which signal should be the targeted signal using an AI-based technique, such as an AI-algorithm, or another technique. For example, the controller may use the energy of one or more signals, the length or duration of one or more signals, an input from one or more sensors (such as a sensor 422), and so forth. The process 500 may then proceed to act 506.

At act 506, the targeted signal is provided to the processing circuit (e.g., the processing circuit 410). The processing circuit then processes the targeted signal (e.g., using AINS or another technique).

In some examples above, the system (e.g., system 100, 200, 300, 400) may feather the processing (e.g., the AI-based processing) when applying said processing to a given signal. For example, rather than fully process an audio signal in a manner that might be abrupt and potentially noticeable to a user, the system can instead begin with relatively less processing of the signal and increase the processing over time (e.g., begin with relatively little attenuation of the background noise and increase the attenuation over time). If the system is able to predict or know when the audio signal will terminate, similar feathering may be applied during termination of the signal, such that the amount of processing is reduced as the signal approaches termination. For example, during the middle of a transmission the attenuation of background noise may be high, but as the signal reaches an end the attenuation may be reduced over time or completely eliminated.

The foregoing examples apply to any type of electrical signal, and need not be limited to purely audio signals.

Various controllers, such as the controller 420, may execute various operations discussed above. Using data stored in associated memory and/or storage, the controller 420 also executes one or more instructions stored on one or more non-transitory computer-readable media, which the controller 420 may include and/or be coupled to, that may result in manipulated data. In some examples, the controller 420 may include one or more processors or other types of controllers. In one example, the controller 420 is or includes at least one processor. In another example, the controller 420 performs at least a portion of the operations discussed above using an application-specific integrated circuit tailored to perform particular operations in addition to, or in lieu of, a general-purpose processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A system for processing a targeted signal, comprising:
a first audio signal input configured to provide a first audio signal;
a second audio signal input configured to provide a second audio signal;
at least one switching device coupled to the first audio signal input and the second audio signal input, and configured to provide the targeted signal to the processing circuit, the targeted signal being based on the first audio signal or the second audio signal;
a processing circuit coupled to the at least one switching device and configured to process the targeted signal; and
at least one controller configured to determine a state of the at least one switching device based on one or more of the first audio signal and the second audio signal.

2. The system of claim 1 wherein processing the targeted signal includes using artificial intelligence-based noise suppression.

3. The system of claim 1 further comprising at least one sensor configured to provide data to the at least one controller.

4. The system of claim 3 wherein the data includes one or more of voice data, energy data, background noise data, and motion data.

5. The system of claim 1 wherein the first audio signal input is a microphone configured to sense a sound and convert the sound into the first audio signal.

6. The system of claim 1 wherein the second audio signal input is a receiver configured to receive the second audio signal.

7. The system of claim 1 wherein the at least one switching device includes a first switching device coupled between the processing circuit and the first audio signal input and a second switching device coupled between the processing circuit and the second audio signal input, the at least one controller being configured to control respective states of both the first switching device and the second switching device.

8. A system for processing audio signals, comprising:
a transceiver;
an input-output interface;
one or more switching devices coupled to the transceiver and coupled to the input-output interface;
a processing circuit coupled to the one or more switching devices; and
at least one controller coupled to the processing circuit and coupled to the one or more switching devices and configured to:
detect an RX signal received at the transceiver,
detect a TX signal received at the input-output interface, and
based on the RX signal and the TX signal, control the one or more switching devices to route one of the TX signal or the RX signal to the processing circuit and route the other of the TX signal or RX signal to the transceiver or input-output interface.

9. The system of claim 8 wherein the transceiver includes a receiver configured to receive RX audio signals, and a transmitter configured to transmit TX audio signals.

10. The system of claim 9 wherein the input-output interface includes a microphone configured to convert sound into TX audio signals, and one or more speakers configured to convert RX audio signals into sound.

11. The system of claim 10 wherein the transmitter is coupled to a first switching device of the one or more switching devices, and the receiver is coupled to the first switching device.

12. The system of claim 11 wherein the microphone is coupled to a second switching device of the one or more switching devices, and the one or more speakers are coupled to the second switching device.

13. The system of claim 12 wherein the first switching device is coupled to the second switching device.

14. The system of claim 13 wherein the first switching device is configured to selectively couple the transmitter and receiver to the processing circuit and second switching device.

15. The system of claim 14 wherein the second switching device is configured to selectively couple the microphone and the one or more speakers to the processing circuit and first switching device.

16. The system of claim 15 wherein the at least one controller is further configured to control a state of the one or more switching devices, including the first switching device and the second switching device, based on one or more of the RX audio signals or the TX audio signals.

17. The system of claim 8 further comprising at least one sensor configured to provide data to the at least one controller.

18. A method of processing an audio signal, comprising:
receiving two or more audio signals;
determining a first audio signal of the two or more audio signals to be a targeted audio signal, the targeted audio signal being an audio signal of the one or more audio signals that corresponds to a most important audio signal among the one or more audio signals;
determining at least one second audio signal of the two or more audio signals to be a bypassed audio signal, the bypassed audio signal being an audio signal that is less important that the targeted audio signal;
forwarding the bypassed audio signal to a transmitter or receiver; and
processing the targeted audio signal to change at least one characteristic of the targeted audio signal.

19. The method of claim 18 further comprising determining which audio signal of the two or more audio signals is the most important audio signal based on at least one element of a set, the set including:
motion of a user's jaw,
duration of the audio signal,
relative power of the audio signal with respect to power of other audio signals of the two or more audio signals, or
frequency components of the audio signal.

20. The method of claim 18 further comprising forwarding the targeted audio signal to a transmitter or receiver responsive to processing the targeted audio signal.
